(19) United States
(12) Patent Application Publication
(10) Pub. No.: US 2012/0020227 A1
(43) Pub. Date: Jan. 26, 2012

(54) COMPLEMENTARY NETWORK QUALITY TESTING METHOD

(75) Inventors: Yi-Neng Lin, Hsnchu (TW); Tso-Chiung Yeh, Hsinchu (TW)

(73) Assignee: FIBER LOGIC COMMUNICATIONS, INC., Hsinchu (TW)

(21) Appl. No.: 12/900,199

(22) Filed: Oct. 7, 2010

(30) Foreign Application Priority Data
Jul. 23, 2010 (TW) 099124367

(51) Int. Cl. H04L 12/26

(52) U.S. Cl. 370/252

(57) ABSTRACT

A complementary network quality testing method for conducting a test on the quality of service with regard to data transmission taking place in a telecommunication network includes setting up a committed bucket of a committed burst size to receive tokens introduced thereinto at a committed information rate; receiving normal protocol data units and/or test protocol data units, followed by storing the normal protocol data units in a data queue and/or storing the test protocol data units in a test queue; determining whether the normal protocol data units are present in the data queue; and retrieving selectively the test protocol data units from the test queue or determining, selectively and again, whether the normal protocol data units are present in the data queue, depending on whether the tokens are present in the committed bucket.

### CROSS-REFERENCE TO RELATED APPLICATION

This non-provisional application claims priority under 35 U.S.C. §119(a) on Patent Application No(s). 099124367 filed in Taiwan, R.O.C. on 23 Jul., 2010, the entire contents of which are hereby incorporated by reference.

### FIELD OF THE INVENTION

The present invention relates to a complementary network quality testing method, and more particularly, to a complementary network quality testing method for conducting a test, in a differentiated service framework composed of a plurality of conditioners of Quality Of Service (QoS conditioners), on complementary data transmission network quality without any additional self-contained system.

### BACKGROUND OF THE INVENTION

Conventional data network provides an assurance of quality of service. Due to the ever-increasing reach of telecommunication services, the assurance of quality of service is made available to the telecommunication network services nowadays. In general, a telecommunication network provider is also known as a network service provider, and is supposed to ensure the quality of service with regard to data transmission taking place in a telecommunication network accessible to network service users, including ensuring upstream/downstream bandwidth, for example. The service referred to above is judged according to the characteristics, such as throughput, delay, jitter, or loss, of data transmission taking place in a telecommunication network. By judging the quality of data transmission, the network service provider can formulate service level agreements and the service rates corresponding thereto.

Techniques most widely used to provide assurance of quality of service are namely: differentiated service, and policy framework. The techniques for assuring quality of service are used in edge routers or interior routers for the Internet protocols or used in network frameworks that serve the purposes described above, such as routers or switches for use in Carrier-grade Ethernet Networks or Gigabit Passive Optical Networks (GPON).

Differentiated service is effectuated by a plurality of conditioners of Quality Of Service (QoS conditioners). Referring to FIG. 1, a QoS conditioner 1 comprises a CLASSIFIER 2, a METER 4, a DROPPER 6, a MARKER 8, a QUEUING UNIT 10, and a SHAPER 12. The CLASSIFIER 2 selectively judges a protocol data unit according to specific parameters. The METER 4 marks any unwanted (such as excess or non-conforming) ones of the protocol data units. The DROPPER 6 discards the unwanted and marked ones of the protocol data units. The MARKER 8 gives the protocol data units a specific mark or color according to the behavior of the protocol data units or commercial rules. The QUEUING UNIT 10 discerns the protocol data units according to the mark or color thereof and places the protocol data units in an appropriate queue. The SHAPER 12 controls the speed of outbound transmission in a manner that no surge of data flows may happen thereto.

Furthermore, to provide an assurance of quality of service with regard to data transmission taking place in a telecommunication network accessible to network service users, network service providers have to verify the assurance of quality of service by testing the outcome of network data transmission. In this regard, network service providers put an appropriate amount of test protocol data units in a network so as to judge the quality of service of data transmission. As disclosed in the prior art, the time to put the test protocol data units in a network depends on the testing time, namely out-of-service and in-service. The out-of-service test refers to sending out a test protocol data units for use in a simple test when the bandwidth is not occupied by any user. The in-service test is conducted at a scenario where a test protocol data unit is sent out while a network service user is conveying a normal protocol data unit. To conduct the in-service test, considerations have to be given to the need to enable a network service user to maintain a normal flow rate of data transmission in the course of the test. The in-service test, which is also known as a complementary network service test, is effective in making good use of redundant and unoccupied bandwidth.

Nonetheless, as disclosed in the prior art, an additional self-contained system is required for testing network data transmission service by conducting the complementary network service test. The additional self-contained system inevitably requires extra equipment and incurs testing costs. Hence, it is imperative to provide a method for conducting the complementary network service test without an additional self-contained system.

### SUMMARY OF THE INVENTION

It is an objective of the present invention to provide a complementary network quality testing method for testing the quality of service with regard to data transmission taking place in a telecommunication network and testing the quality of service with regard to a complementary network operating under the original monitor framework without any additional self-contained system.

In an embodiment of the present invention, the complementary network quality testing method is configured for use in testing the quality of service with regard to data transmission taking place in a telecommunication network. The method comprises the steps of: setting up a committed bucket configured to receive tokens and characterized by a committed burst size, wherein the tokens are introduced into the committed bucket at a committed information rate; receiving normal protocol data units and/or test protocol data units so as for the normal protocol data units thus received to be stored in a data queue and/or the test protocol data units thus received to be stored in a test queue; and determining whether the protocol data units are present in the data queue, retrieving the normal protocol data units from the data queue in sequence upon affirmative determination, and retrieving selectively the test protocol data units from the test queue or determining, selectively and again, whether any said normal protocol data units are present in the data queue, depending on whether any said tokens are present in the committed bucket, upon negative determination. In other words, the method involves retrieving the test protocol data units from the test queue upon determination of the presence of tokens in the committed bucket and determining, again, whether the normal protocol data units are present in the data queue upon determination of the absence of tokens from the committed bucket.

In another embodiment, the complementary network quality testing method is configured for conducting a test on the quality of service with regard to data transmission taking place in a telecommunication network. The method comprises the steps of: setting up a committed bucket configured to receive tokens and characterized by a committed burst size, wherein the tokens are each introduced into the committed bucket at a committed information rate; setting up an excess bucket configured to receive the tokens and characterized by an excess burst size, wherein the tokens are each introduced into the excess bucket at an excess information rate; receiving normal protocol data units and/or test protocol data units so as for the normal protocol data units thus received to be stored in a data queue and/or the test protocol data units thus received to be stored in a test queue; and determining whether the normal protocol data units are present in the data queue, retrieving the normal protocol data units from the data queue in sequence upon affirmative determination, and retrieving selectively the test protocol data units from the test queue or determining, selectively and again, whether any said normal protocol data units are present in the data queue, depending on whether any said tokens are present in the committed bucket and/or the excess bucket, upon negative determination.

Compared with conventional technology, the complementary network quality testing method of the present invention solves a known problem, that is, an additional self-contained system is required for a differentiated service framework in order for test protocol data units to be sent out to conduct a test. The present invention has another advantage over the prior art, as the method of the present invention involves using one or a plurality of buckets for providing a basis of judgment as to whether to send a normal protocol data units and a test protocol data units to a queuing units of conditioners of quality of service (QoS conditioners). In another preferred embodiment of the present invention, test protocol data units are sent out to conduct a test on the quality of service with regard to network-based data transmission on condition that: no normal protocol data units has been sent out; and one and/or a plurality of bucket still has a token.

### BRIEF DESCRIPTION OF THE DRAWINGS

A detailed description of further features and advantages of the present invention is given below so that a person skilled in the art can understand and implement the technical contents of the present invention and readily comprehend the objectives, features, and advantages thereof by reviewing the disclosure of the present specification and the appended claims in conjunction with the accompanying drawings, in which:

FIG. 1 is a schematic view of conventional conditioners of quality of service;

FIG. 2 through FIG. 4 are flow charts of a complementary network quality testing method in various embodiments of the present invention, respectively;

FIG. 5 is a schematic view of the complementary network quality testing method in the various embodiments of the present invention;

FIG. 6 through FIG. 8 are flow charts of the complementary network quality testing method in various further embodiments of the present invention; and

FIG. 9 is a schematic view of the complementary network quality testing method in the various further embodiments of the present invention.

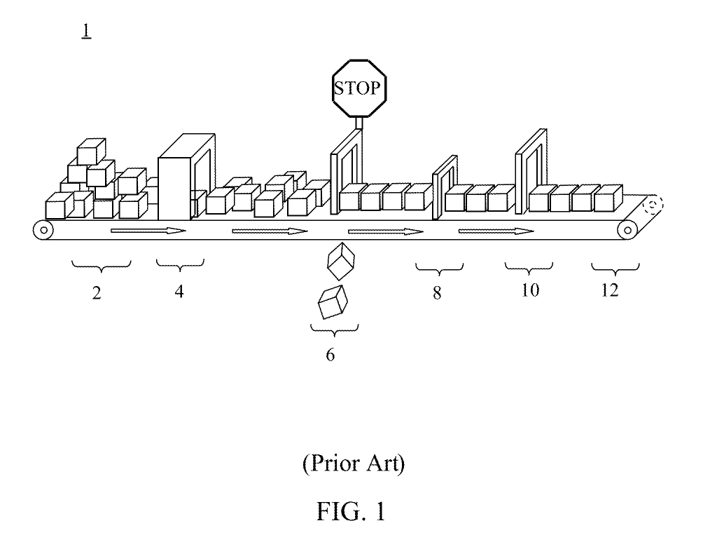

### DETAILED DESCRIPTION OF THE PREFERRED EMBODIMENTS

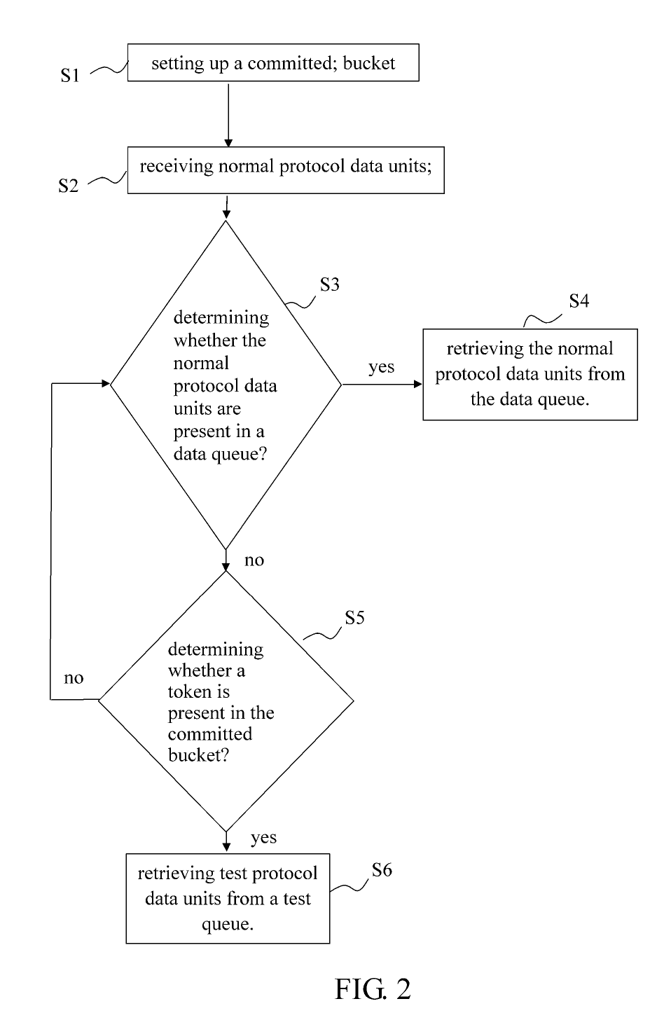

Referring to FIG. 2, there is shown a flow chart of a complementary network quality testing method in an embodiment of the present invention. In this embodiment, the complementary network quality testing method is configured for use in conducting a test on the quality of service with regard to data transmission taking place in a telecommunication network. The process of the method starts with step S1 which involves setting up a committed bucket configured to receive tokens, characterized by a committed burst size, and capable of accommodating the tokens of a number commensurate with the committed burst size, wherein the tokens are each introduced into the committed bucket at a committed information rate and defined as committed tokens when doing so. Then, the process of the method goes to step S2 which involves receiving normal protocol data units so as for the normal protocol data units thus received to be stored in a data queue. The process of the method goes to step S3 which involves determining whether the normal protocol data units are present in the data queue. Affirmative determination and negative determination in step S3 bring the process of the method to step S4 and step S5, respectively. Step S4 involves retrieving the normal protocol data units from the data queue. Step S5 involves determining whether a token is present in the committed bucket. Affirmative determination and negative determination in step S5 bring the process of the method to step S6 and step S3, respectively. Step S6 involves retrieving test protocol data units from a test queue. Step S3 and step S5 are alternated to form a loop.

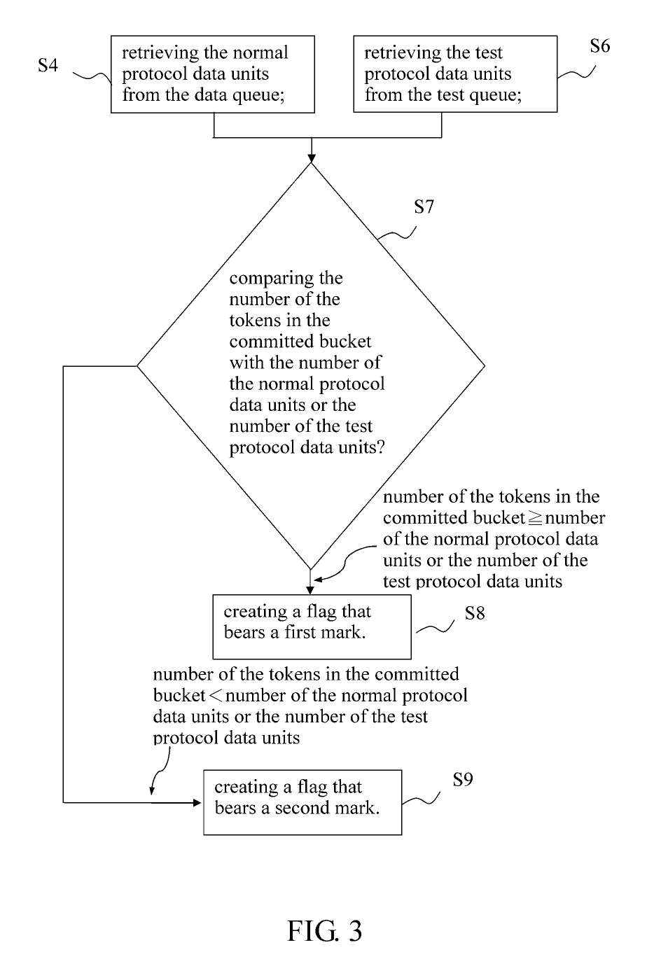

Referring to FIG. 3, there is shown a flow chart of the complementary network quality testing method in a variant embodiment of the present invention. Step S7 in this embodiment follows step S4 or step S6 of the preceding embodiment, and involves comparing the number of the tokens in the committed bucket with the number of the normal protocol data units or the number of the test protocol data units so as to create a corresponding flag in the normal protocol data units or the test protocol data unit. Step S7 is followed by step S8 if the number of the tokens in the committed bucket is larger than or equal to the number of the normal protocol data units or the number of the test protocol data units. Step S7 is followed by step S9 if the number of the tokens in the committed bucket is less than the number of the normal protocol data units or the number of the test protocol data units. Step S8 involves creating a flag that bears a first mark, wherein the first mark indicates that the bandwidth is sufficient to convey the normal protocol data units or the test protocol data units. Step S9 involves creating a flag that bears a second mark, wherein the second mark indicates that the bandwidth is insufficient to convey the normal protocol data units or the test protocol data units, or indicates that the bandwidth has to be overloaded so as to convey the normal protocol data units or the test protocol data units, and in consequence no test protocol data units is conveyed. In an embodiment, the marks are distinguished from each other by color, with the first mark denoted in green and the second mark in red, for example.

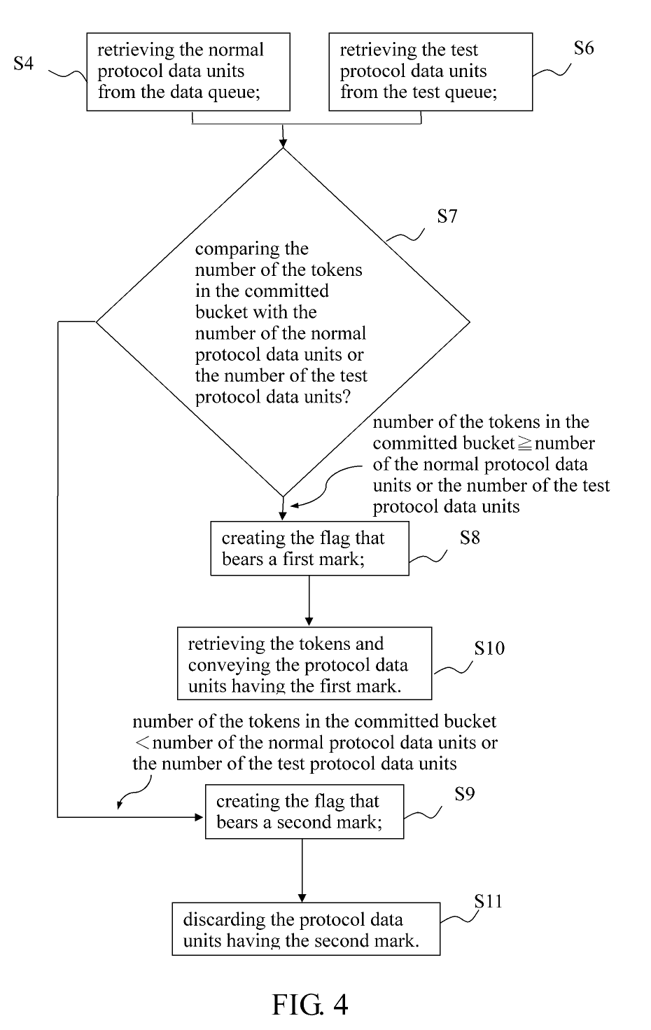

Referring to FIG. 4, there is shown a flow chart of the complementary network quality testing method in another variant embodiment of the present invention. In this embodiment, step S8 and step S9 are followed by step S10 and step S11, respectively. Step S10 involves retrieving the tokens from the committed bucket and conveying the normal protocol data units or the test protocol data units having the first mark. Step S11 involves discarding the normal protocol data units or the test protocol data units having the second mark.

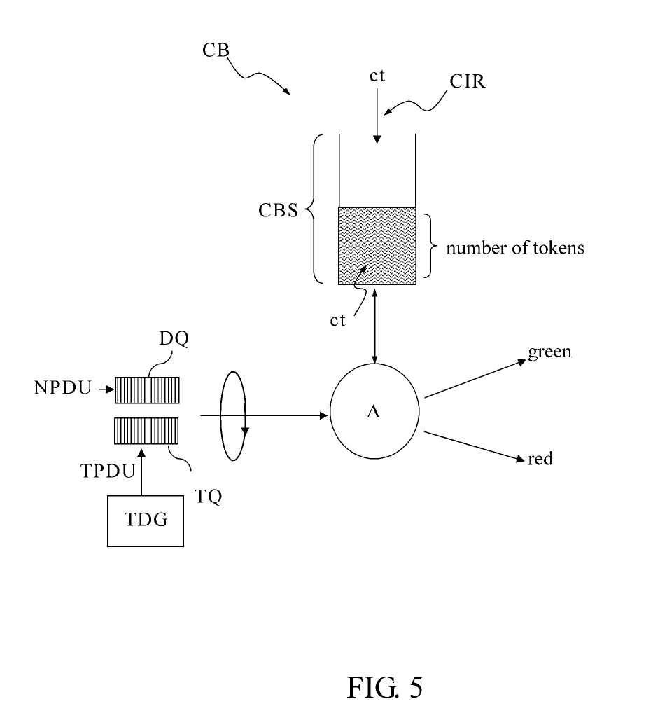

Referring to FIG. 5, there is shown a schematic view of the complementary network quality testing method in the various embodiments of the present invention. In this embodiment, the complementary network quality testing method involves receiving normal protocol data units NPDU and/or test protocol data units TPDU. The test protocol data units are generated by a test protocol data generator TPDG. The method further involves storing the normal protocol data units NPDU in a data queue DQ and/or storing the test protocol data units TPDU in a test queue TQ; meanwhile, tokens ct are each introduced into a committed bucket CB of a committed burst size CBS at a committed information rate CIR, and then the algorithm A confirms whether the normal protocol data units NPDU are present in the data queue DQ.

If it is confirmed that the normal protocol data units NPDU are present in the data queue DQ, the normal protocol data units NPDU will be retrieved from the data queue DQ in sequence, and the algorithm A will compare the number of the tokens ct in the committed bucket CB with the number of the normal protocol data units NPDU. For example, the algorithm A is a single-rate Three-Color Meter/Marker. Furthermore, a flag for use with the normal protocol data units NPDU is created according to the result of the comparison. If the number of the tokens ct in the committed bucket CB is larger than or equal to the number of the normal protocol data units NPDU, a flag that bears the first mark will be created. The first mark is denoted in green. The first mark suggests retrieving the tokens ct from the committed bucket CB and conveying the normal protocol data units NPDU having the first mark. If the number of the tokens ct in the committed bucket CB is less than the number of the normal protocol data units NPDU, a flag that bears the second mark will be created. The second mark is denoted in red. The second mark suggests discarding the normal protocol data units NPDU having the second mark.

If it is determined that none of the normal protocol data units is present in the data queue DQ, it will be necessary to determine whether one of the tokens ct is present in the committed bucket CB. Upon determination that one of the tokens ct is present in the committed bucket CB, it is necessary to retrieve the test protocol data units TPDU from the test queue TQ and further compare the number of the tokens ct in the committed bucket CB with the number of the test protocol data units TPDU so as to create a corresponding flag in the test protocol data units TPDU. Upon determination that the number of the tokens ct in the committed bucket CB is larger than or equal to the number of the test protocol data units TPDU, it is necessary to create a flag that bears a first mark. The first mark is denoted in green. The first mark suggests retrieving the tokens ct from the committed bucket CB and conveying the test protocol data units TPDU having the first mark. Upon determination that the number of the tokens ct in the committed bucket CB is less than the number of the test protocol data units TPDU, it is necessary to create a flag that bears a second mark. The second mark is denoted in red. The second mark suggests discarding the test protocol data units TPDU having the second mark. Upon determination that none of the tokens ct is present in the committed bucket CB, it is necessary to determine, again, whether the normal protocol data units NPDU are present in the data queue DQ, until and unless the normal protocol data units NPDU are absent from the data queue DQ. Alternating between the aforesaid judgment processes takes place by means of a loop.

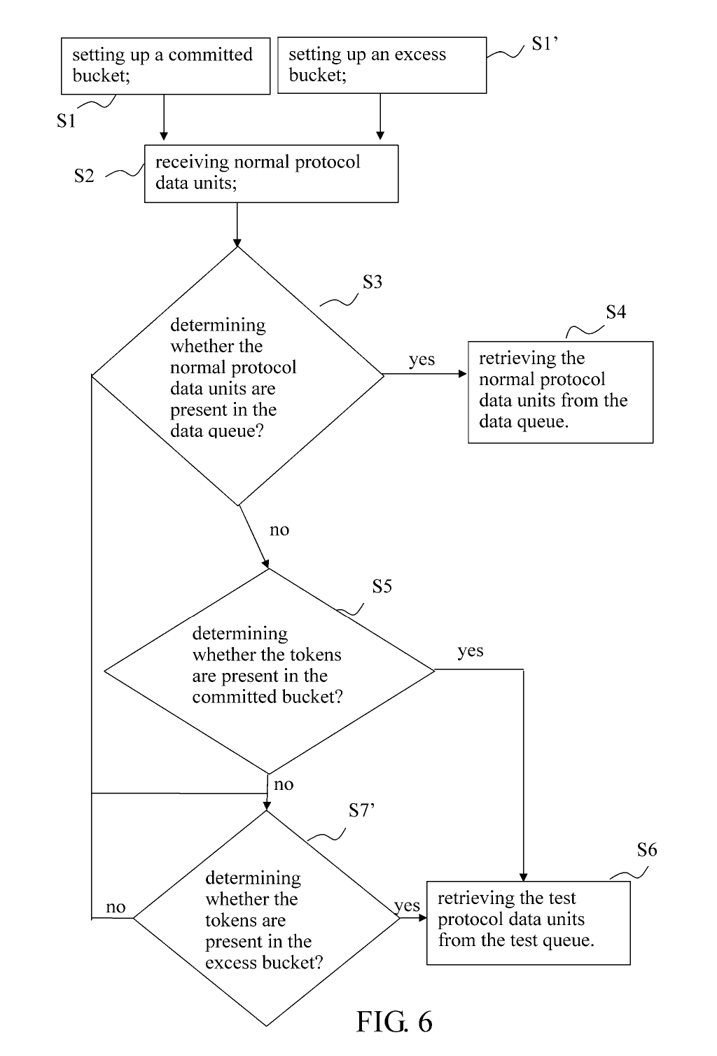

Referring to FIG. 6, there is shown a flow chart of the complementary network quality testing method in a further variant embodiment of the present invention. In this embodiment, the complementary network quality testing method is configured for conducting a test on the quality of service with regard to data transmission taking place in a telecommunication network, and the process of the method starts with step S1 and step S1′ for setting up a committed bucket and an excess bucket, respectively, in the same manner as it is in the aforesaid embodiments. The excess bucket is configured to receive tokens and characterized by an excess burst size large enough for the excess bucket to accommodate the tokens of a number commensurate with the excess burst size. The tokens are each introduced into the excess bucket at an excess information rate. In an embodiment, the tokens are defined as committed tokens while being introduced into the excess bucket. Step S1 and step S1′ are each followed by step S2. Step S2 involves receiving the normal protocol data units so as for the normal protocol data units thus received to be stored in a data queue. Step S2 is followed by step S3. Step S3 involves determining whether the normal protocol data units are present in the data queue. Step S3 is followed by step S4 or step S5, depending on the result of determination in step S3. Step S4 starts as soon as it is determined in step S3 that the normal protocol data units are present in the data queue. Step S4 involves retrieving the normal protocol data units from the data queue in sequence. Step S5 starts as soon as it is determined in step S3 that the normal protocol data units are absent from the data queue. Step S5 involves determining whether the tokens are present in the committed bucket. Step S5 is followed by step S6, step S3, or step S7′, depending on the result of determination in step S5. Step S6 starts as soon as it is determined in step S5 that the tokens are present in the committed bucket. Step S6 involves retrieving the test protocol data units from the test queue. Upon determination in step S5 that the tokens are absent from the committed bucket, the process of the method either returns to step S3 or goes to step S7′. As described above, step S3 involves determining whether the normal protocol data units are present in the data queue. Step S7′ involves determining whether the tokens are present in the excess bucket. Step S7′ is followed by step S6 in response to affirmative determination or step S3 in response to negative determination. Step S6 involves retrieving the test protocol data units from the test queue. As described above, step S3 involves determining whether the normal protocol data units are present in the data queue. In so doing, step S3, step S5, and step S7′ together form a loop.

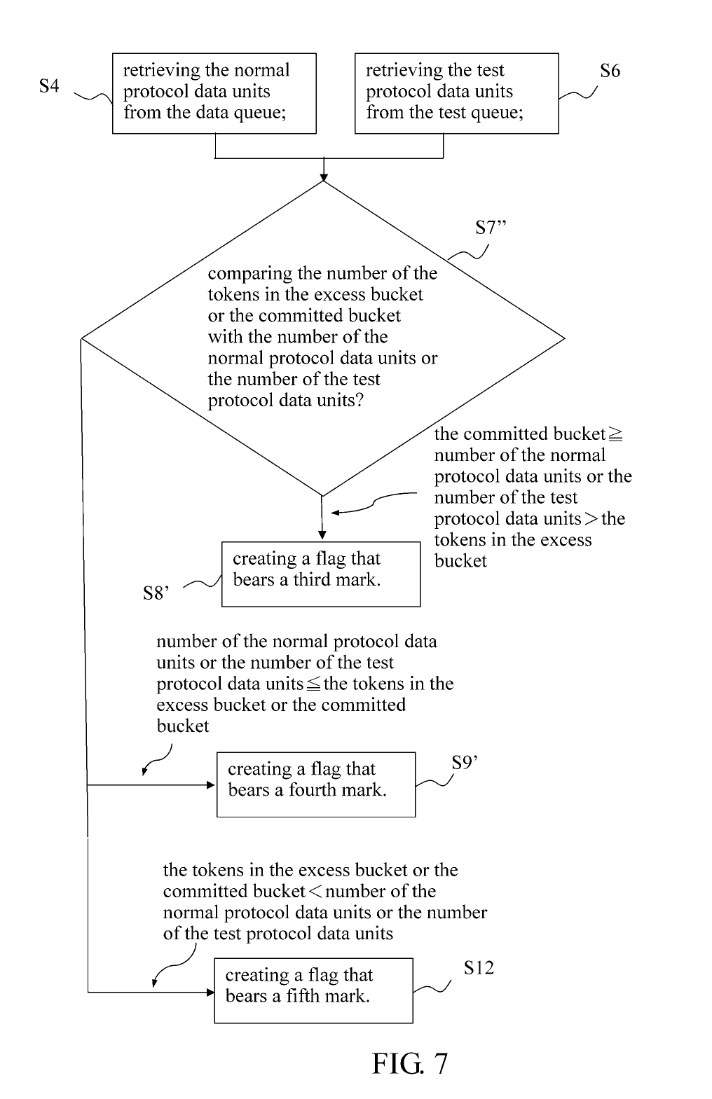

Referring to FIG. 7, there is shown a flow chart of the complementary network quality testing method in a further variant embodiment of the present invention. In this embodiment, step S4 or step S6 is followed by step S7″. Step S7″ involves comparing the number of the tokens in the excess bucket or the committed bucket with the number of the normal protocol data units or the number of the test protocol data units so as to create a corresponding flag in the normal protocol data unit or the test protocol data unit. Step S7″ is followed by step S8′, step S9′, or step S12, depending on the result of determination in step S7″. Step S8′ involves creating a flag that bears a third mark on condition that the number of the normal protocol data units or the number of the test protocol data units is less than or equal to the number of the tokens in the committed bucket but larger than the number of the tokens in the excess bucket. Step S9′ involves creating a flag that bears a fourth mark on condition that the number of the normal protocol data units or the number of the test protocol data units is larger than the number of the tokens in the committed bucket but less than or equal to the number of the tokens in the excess bucket. Step S12 involves creating a flag that bears a fifth mark on condition that both the number of the tokens in the excess bucket and the number of the tokens in the committed bucket are less than the number of the normal protocol data units or the number of the test protocol data units. In an embodiment, the aforesaid marks are denoted in different colors to indicate respective states. For instance, the third mark is denoted in green, the fourth mark in yellow, and the fifth mark in red.

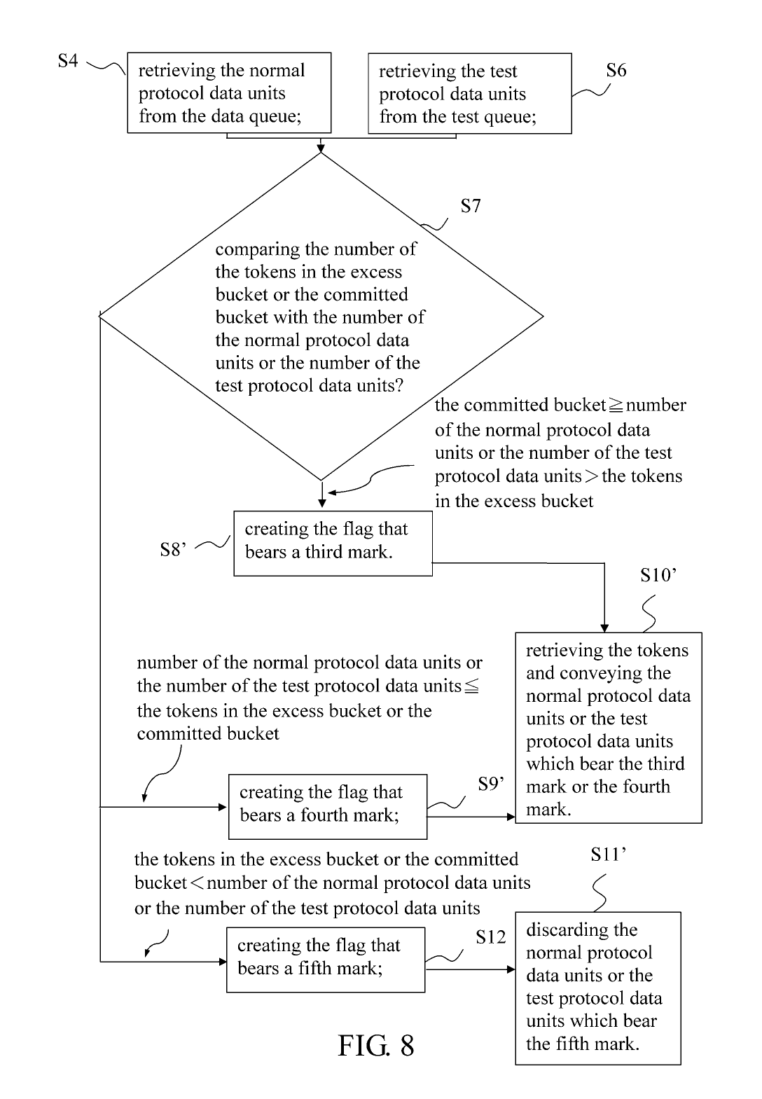

Referring to FIG. 8, there is shown a flow chart of the complementary network quality testing method in a further variant embodiment of the present invention. In addition to step S8′, step S9′ and step S12 of the preceding embodiment, this embodiment includes step S10′ and step S11′ which follow step S8′, step S9′ and step S12, respectively. Step S10′ involves retrieving the tokens from the committed bucket and/or the excess bucket and conveying the normal protocol data units or the test protocol data units which bear the third mark or the fourth mark. Step S11′ involves discarding the normal protocol data units or the test protocol data units which bear the fifth mark.

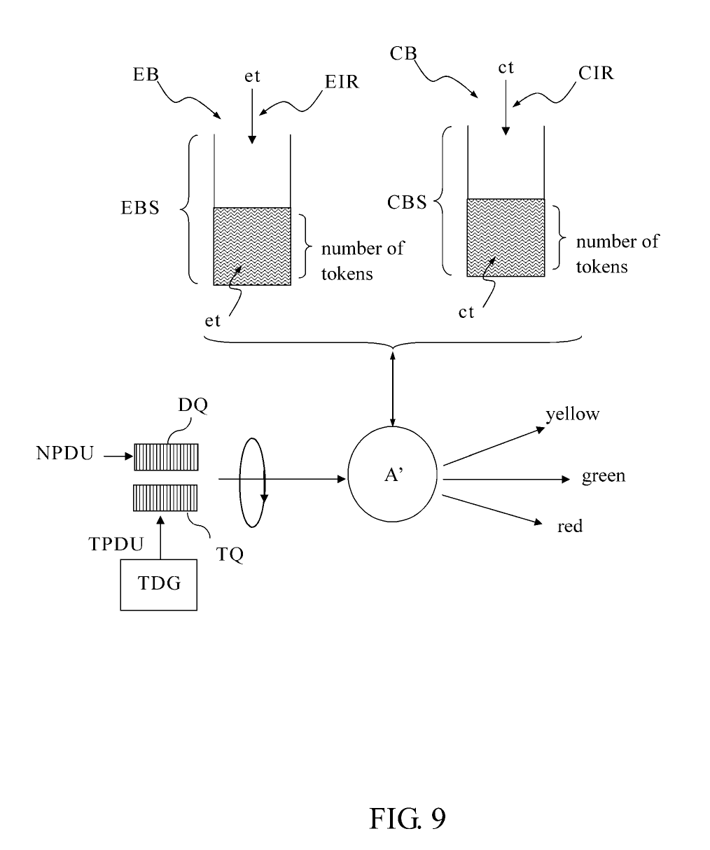

Referring to FIG. 9, there is shown a schematic view of the complementary network quality testing method in the various further embodiments of the present invention. In this embodiment, the complementary network quality testing method involves receiving the normal protocol data units NPDU and/or the test protocol data units TPDU. The test protocol data units are generated by a test protocol data generator TPDG. The normal protocol data units NPDU are stored in a data queue DQ, and/or the test protocol data units TPDU are stored in a test queue TQ; meanwhile, the tokens ct are each introduced into the committed bucket CB of the committed burst size CBS at the committed information rate CIR, and tokens et are each introduced into an excess bucket EB of an excess burst size EBS at an excess information rate EIR, so as for an algorithm A′ to confirm whether the normal protocol data units NPDU are present in the data queue DQ. For example, the algorithm A′ is a two-rate Three-Color Meter/Marker).

Upon determination that the normal protocol data units NPDU are present in the data queue DQ, it is necessary to retrieve the normal protocol data units NPDU from the data queue DQ in sequence and compare, using the algorithm A′, the number of the tokens ct in the committed bucket CB and the number of the tokens et in the excess bucket EB with the number of the normal protocol data units NPDU. Furthermore, a corresponding flag is created in the normal protocol data units NPDU according to the result of the comparison. Upon determination that the number of the normal protocol data units NPDU is less than or equal to the number of the tokens ct in the committed bucket CB but larger than the number of the tokens et in the excess bucket EB, the flag that bears the third mark is created. The third mark is denoted in green. The third mark suggests retrieving the tokens ct, et from the committed bucket CB and/or the excess bucket EB and conveying the normal protocol data units having the third mark. Upon determination that the number of the tokens et in the excess bucket EB is larger than or equal to the number of the normal protocol data units NPDU, the flag that bears the fourth mark is created. The fourth mark is denoted in yellow. The fourth mark suggests retrieving the tokens ct, et from the committed bucket CB and/or the excess bucket EB and conveying the normal protocol data units having the fourth mark. Upon determination that both the number of the tokens et in the excess bucket EB and the number of the tokens ct in the committed bucket CB are less than the number of the normal protocol data units NPDU, the flag that bears the fifth mark is created. The fifth mark is denoted in red. The fifth mark suggests discarding the normal protocol data units having the fifth mark.

Upon determination that the normal protocol data units NPDU are absent from the data queue DQ, it is necessary to retrieve the test protocol data units TPDU from the test queue TQ in sequence, compare, by the algorithm A′, the number of the tokens ct in the committed bucket CB and the number of the tokens et in the excess bucket EB with the number of the test protocol data units TPDU, and create the aforesaid marks.

In the above embodiments, the tokens are introduced into the committed bucket and the excess bucket without exceeding the committed burst size and the excess burst size, respectively. However, in another embodiment, once the committed tokens being introduced into the committed bucket at a committed information rate are about to overflow the committed bucket (that is, when the number of the tokens in the committed bucket exceeds the committed burst size), the tokens will be persistently introduced into the excess bucket at a committed information rate.

Compared with the prior art, the present invention provides a complementary network quality testing method that overcomes a drawback of the prior art, that is, an additional self-contained system is required for sending test protocol data units to conduct a test in a conventional differentiated service framework. Also, the present invention provides one or a plurality of buckets that serve as a determinant basis as to whether to send the normal protocol data units and the test protocol data units to a queuing unit of conditioners of quality of service (QoS conditioners). Preferably, the present invention teaches sending test protocol data units on condition that no normal protocol data unit has been sent but one and/or a plurality of buckets still have tokens, so as to conduct a test on quality of service regarding network-based data transmission.

The present invention is disclosed above by preferred embodiments. Persons skilled in the art understand that the preferred embodiments of the present invention are intended to illustrate the present invention, but are not intended to be restrictive of the scope of the present invention. Hence, all equivalent modifications and replacements made to the foregoing embodiments without departing from the spirit embodied in the disclosure of the present invention should fall within the scope of the present invention as set forth in the appended claims. Hence, the scope of the protection for the present invention shall be defined by the appended claims.

What is claimed is:

1. A complementary network quality testing method for conducting a test on quality of service with regard to data transmission taking place in a telecommunication network, the method comprising the steps of:
setting up a committed bucket configured to receive tokens and characterized by a committed burst size, wherein the tokens are each introduced into the committed bucket at a committed information rate;
receiving normal protocol data units and/or test protocol data units so as for the normal protocol data units thus received to be stored in a data queue and/or the test protocol data units thus received to be stored in a test queue; and
determining whether any said normal protocol data units are present in the data queue, retrieving the normal protocol data units from the data queue in sequence upon affirmative determination, and retrieving selectively the test protocol data units from the test queue or determining, selectively and again, whether any said normal protocol data units are present in the data queue, depending on whether any said tokens are present in the committed bucket, upon negative determination.

2. The complementary network quality testing method of claim 1, wherein the tokens are introduced into the committed bucket without exceeding the committed burst size.

3. The complementary network quality testing method of claim 2, further comprising comparing the number of the tokens in the committed bucket with the number of the normal protocol data units or the number of the test protocol data units so as to create a corresponding flag in the normal protocol data units or the test protocol data units.

4. The complementary network quality testing method of claim 3, further comprising creating the flag having a first mark upon determination that the number of the tokens in the committed bucket is larger than or equal to the number of the normal protocol data units or the number of the test protocol data units.

5. The complementary network quality testing method of claim 4, further comprising retrieving the tokens from the committed bucket and conveying the normal protocol data units or the test protocol data units having the first mark.

6. The complementary network quality testing method of claim 3, further comprising creating the flag having a second mark upon determination that the number of the tokens in the committed bucket is less than the number of the normal protocol data units or the number of the test protocol data units.

7. The complementary network quality testing method of claim 6, further comprising discarding the normal protocol data units or the test protocol data units having the second mark.

8. A complementary network quality testing method for conducting a test on quality of service with regard to data transmission taking place in a telecommunication network, the method comprising the steps of:
setting up a committed bucket configured to receive tokens and characterized by a committed burst size, wherein the tokens are each introduced into the committed bucket at a committed information rate;
setting up an excess bucket configured to receive the tokens and characterized by an excess burst size, wherein the tokens are each introduced into the excess bucket at an excess information rate;
receiving normal protocol data units and/or test protocol data units so as for the normal protocol data units thus received to be stored in a data queue and/or the test protocol data units thus received to be stored in a test queue; and
determining whether the normal protocol data units are present in the data queue, retrieving the normal protocol data units from the data queue in sequence upon affirmative determination, and retrieving selectively the test protocol data units from the test queue or determining, selectively and again, whether any said normal protocol data units are present in the data queue, depending on whether any said tokens are present in the committed bucket and/or the excess bucket, upon negative determination.

9. The complementary network quality testing method of claim 8, wherein the tokens are introduced into the committed bucket and the excess bucket without exceeding the committed burst size and the excess burst size, respectively.

10. The complementary network quality testing method of claim 9, further comprising comparing the number of the tokens in the excess bucket or the committed bucket with the number of the normal protocol data units or the number of the test protocol data units so as to create a corresponding flag in the normal protocol data units or the test protocol data units.

11. The complementary network quality testing method of claim 10, further comprising creating a flag having a third mark upon determination that the number of the normal protocol data units or the number of the test protocol data units is less than or equal to the number of the tokens in the committed bucket but larger than the number of the tokens in the excess bucket.

12. The complementary network quality testing method of claim 11, further comprising retrieving the tokens from the committed bucket or the excess bucket and conveying the test protocol data units or the normal protocol data units having the third mark or the fourth mark.

13. The complementary network quality testing method of claim 10, further comprising creating a flag having a fourth mark upon determination that the number of the tokens in the excess bucket is larger than or equal to the number of the normal protocol data units or the number of the test protocol data units.

14. The complementary network quality testing method of claim 13, further comprising retrieving the tokens from the committed bucket or the excess bucket and conveying the test protocol data units or the normal protocol data units having the third mark or the fourth mark.

15. The complementary network quality testing method of claim 10, further comprising creating a flag having a fifth mark upon determination that both the number of the tokens in the excess bucket and the number of the tokens in the committed bucket are less than the number of the normal protocol data units or the number of the test protocol data units.

16. The complementary network quality testing method of claim 15, further comprising discarding the normal protocol data units or the test protocol data units having the fifth mark.

17. The complementary network quality testing method of claim 8, wherein after being introduced into the committed bucket and exceeding the committed burst size, the tokens are introduced into the excess bucket at the excess information rate equaled to committed information rate.
